(19) United States
(12) Patent Application Publication
(10) Pub. No.: US 2026/0049181 A1
(43) Pub. Date: Feb. 19, 2026

(54) PHOTOCURABLE RESIN COMPOSITION

(71) Applicant: The University of Birmingham, Birmingham (GB)

(72) Inventors: Andrew Peter DOVE, Birmingham (GB); Joshua Charles WORCH, Birmingham (GB)

(21) Appl. No.: 19/102,116

(22) PCT Filed: Aug. 8, 2023
(86) PCT No.: PCT/GB2023/052091

§ 371 Date: Feb. 7, 2025

(30) Foreign Application Priority Data
Aug. 8, 2022 (GB) 2211507.5

(51) Int. Cl. C08G 75/14; C08J 11/28

(52) U.S. Cl. CPC C08G 75/14; C08J 11/28; C08J 2381/04

(57) ABSTRACT

A photocurable resin composition comprising a crosslinker (104), the crosslinker (104) comprising plural cyclic disulphide groups and wherein the concentration of disulphide bonds in the resin composition is at least 10 wt. %.

This invention relates generally to photocurable resin compositions, for example, which are suitable for use in 3D printing. More specifically, although not exclusively, this invention relates to photocurable resin compositions comprising monomers having disulphide bonds, methods of fabricating parts from the same, and parts fabricated from the same.

Photocurable resin compositions suitable for use in 3D printing are known. Many of these photocurable resins, particularly those that are commercially available, make use of (meth)acrylate functional groups to irreversibly crosslink the structure. A photoinitiator additive is commonly added to the resin composition to induce radical initiation upon light irradiation, thereby inducing free-radical polymerisation and crosslinking of the (meth)acrylate-containing resin components during the printing process. However, photocurable resin compositions of this nature have a number of drawbacks, at least that the functional groups are highly toxic and classed as sensitisers. In addition, these chemicals are also drawn from non-renewable resources. There are also end-of-life issues in that the crosslinked polymer materials are not fully recyclable due to the strong covalent bonds formed during the crosslinking reaction. Consequently, there are significant sustainability issues with photo-crosslinked 3D printed materials.

Several approaches exist to enable 3D printed materials to be reprocessed or recycled. These may be grouped into three main strategies: 1) Internal dynamic covalent bonds, for example in (meth)acrylated resins; 2) Non-acrylate-based resins using reversible cycloaddition reactions; 3) Non-acrylate-based resins using dynamic cyclic disulphides.

The first of these strategies, wherein internal dynamic covalent bonds are incorporated in photocurable resins (e.g. (meth)acrylated resins), enables the 3D printed material to be reprocessed. However, in some cases there are drawbacks because although the crosslinked material can be partially depolymerised, it is not reprintable unless additional resin (e.g. acrylate resin) is added. The key shortcoming with some of these examples is that the dynamic bond is orthogonal to the photochemical cross-linking reactions, which form strong covalent bonds and are not depolymerisable. Therefore, the resin in these approaches cannot be considered to be fully recyclable in a closed-loop process. Recent literature in this area includes the following publications: Nat Commun 9, 1831 (2018); ACS Appl Mater Interfaces. 2021 Jan. 13; 13(1):1581-1591; Mater. Des. 2021, 197, 109189; Adv. Funct. Mater. 2021, 31(9), 2007173; Materials Horizons 2018, 5 (6), 1042-1046; ACS Appl. Mater. Interfaces 2021, 13 (11), 12789-12796.

In the second of these strategies, wherein non-acrylate-based resins rely on reversible cycloaddition reactions, the crosslinked material may be photo-crosslinked and then subsequently depolymerized back into a photo-curable resin. However, the resin syntheses are non-trivial, and these systems typically require high frequency (<300 nm) and/or continuous light irradiation which makes them inefficient. Also, they have only been used for 2D material fabrication. Recent literature in this area includes the following publications; Macromolecules 2017, 50, 5, 1930-1938; Polym. Chem. 2019, 10 (17), 2134-2142; J. Am. Chem. Soc. 2019, 141 (31), 12329-12337.

The third of these strategies uses cyclic disulphides as recyclable photocurable resins.

The publication “Light-mediated synthesis and reprocessing of dynamic bottlebrush elastomers under Ambient Conditions” (J. Am. Chem. Soc. 2021, 143 (26), 9866-9871) discloses the photopolymerisation and crosslinking of macromonomers comprising a PEG polymer with disulphide groups. Mono- and di-functionalised disulphide PEG macromonomers were used to fabricate 2D materials, which could be reprocessed using light, or partially thermally depolymerised. The concentration of disulphide bonds in the resin composition was between 1.4 to 4.2 wt. %.

The publication “Photo-crosslinking and reductive decrosslinking of polymethacrylate-based copolymers containing 1,2-dithiolane rings” (Macromol. Chem. Phys. 2022, 2100445) discloses the photopolymerisation and crosslinking of polymethacrylate copolymers containing cyclic disulphide pendant groups. These could be de-crosslinked by chemical reduction to thiols, but subsequent recyclability was not shown. The concentration of disulphide bonds in the resin composition was between 1.2 to 3.6 wt. %.

The publication “Photo-crosslinking polymers by dynamic covalent disulfide bonds” (Chem. Commun. 2021, 57 (77), 9838-9841) discloses the photo-crosslinking of polydimethylsiloxane (PDMS) polymers comprising cyclic disulphide pendant groups into 2D materials. The networks were catalytically depolymerised but subsequent recycling was not shown. The concentration of disulphide bonds in the resin composition was 1.5 wt. %.

The publication “Digital light processing of dynamic bottlebrush materials” (Adv. Funct. Mater. 2022, 32 (25), 2200883) discloses the use of macromonomers and crosslinkers each comprising disulphide groups. It was shown that formulations using a bis-disulphide crosslinker were not printable due to slow or incomplete curing. Therefore, it was described that it was crucial to use a PEG-diacrylate crosslinker to enable the formulation to be printable. However, the use of this type of crosslinker means that the printed part cannot be depolymerised and thus is non-recyclable. The concentration of disulphide bonds in the resin composition was between 9.1 to 9.4 wt. %.

It is therefore a first non-exclusive object of the invention to provide a resin composition for printing a 3D part. In particular it is an object to provide a resin composition for printing a 3D part which is able to be (e.g. completely, or substantially completely, or predominantly) depolymerised and (e.g. completely, or substantially completely) repolymerised, in a recyclable or “closed-loop” process.

It is a further non-exclusive object of the invention to provide a resin composition comprising monomers that are simple to synthesise, preferably from renewable feedstocks.

It is a yet further non-exclusive object of the invention to provide a resin composition capable of being 3D printed for example using light, for example using vat photopolymerisation, e.g. digital light processing (DLP), stereolithography (SLA), continuous liquid interface production (CLIP); or volumetric 3D printing, xolography, tomographic reconstruction, or ink-jetting.

Accordingly, a first aspect of the invention provides photocurable resin composition comprising a crosslinker, the crosslinker comprising a plural cyclic disulphide groups and wherein the concentration of disulphide bonds in the resin composition is above 9.5 wt. %, for example at least 10 wt. %.

The photocurable resin composition may comprise plural crosslinkers, preferably each comprising plural cyclic disulphide groups.

Whilst it is possible to use a cross linker on its own, we have found that it may be advantageous to form a photocurable resin from a crosslinker in addition to a reactive diluent or a non-reactive diluent.

A non-reactive diluent may be a solvent. Sample solvents may be selected from acetone, DCM, THF, NMP, DMSO. When using the resin composition to conduct 3D printing, for example, it may be beneficial to use a relatively high boiling point solvent. In some circumstances, it is possible that the use of a solvent may reduce photocure rates. This may be beneficial in some circumstances, for example to increase shelf-life. The reduced photo-cure time might be mitigated by the use of a photoinitiator.

Advantageously, it is possible to use a reactive diluent, i.e. a diluent which reacts with the cross-linker. We have found that reactive diluents which contain disulphide bonds, (preferably fewer disulphide bonds than those in the cross linker) can be used to tune the properties (e.g. the mechanical properties) of the corresponding photo-cured resin by varying the ratio of cross linker to reactive diluent.

The reactive diluent may be a monomer molecule and/or may have a molecular weight of less than 600 gmol⁻¹. Preferably, the reactive diluent contains at least one, and in some embodiments only one, disulphide bond, for example having a low molecular weight (<600 gmol⁻¹) and at least one, preferably only one, disulphide bond.

The photocurable resin composition may comprise plural different diluents, for example plural different reactive diluents and/or at least one reactive diluent and at least one non-reactive diluent.

The use of different crosslinkers and/or one or more reactive diluents may facilitate accurate tuning of mechanical properties of the cured resin.

A further aspect of the invention provides a photocurable resin composition comprising (e.g. consisting of) a diluent, e.g. a reactive diluent, and a crosslinker, the reactive diluent comprising a first (e.g. single) cyclic disulphide group, the crosslinker comprising a second cyclic disulphide group and a third cyclic disulphide group, wherein the concentration of disulphide bonds in the resin composition is at least 9.5 wt. %, e.g. at least 10 wt. %.

A further aspect of the invention provides a photocurable resin composition comprising (e.g. consisting of) a reactive diluent and a crosslinker, the reactive diluent comprising a first (e.g. single) cyclic disulphide group, the crosslinker comprising a second cyclic disulphide group and a third cyclic disulphide group, wherein the molecular weight of the reactive diluent is not greater than 600 gmol⁻¹.

A further aspect of the invention provides a photocurable resin composition comprising (e.g. consisting of) a reactive diluent and a crosslinker, the reactive diluent comprising a first (e.g. single) cyclic disulphide group, the crosslinker comprising a second cyclic disulphide group and a third cyclic disulphide group, wherein the reactive diluent is a monomer.

In embodiments, the concentration of disulphide bonds in the resin composition is at least 9.5 wt. %, or at least 9.6 wt. %, or at least 9.7 wt. %, or at least 9.8 wt. %, or at least 9.9 wt. %, or at least 10 wt. %. The concentration of disulphide bonds (wt. %) in the resin composition is calculated as follows:

$$Atomic mass of sulphur = 32.065 g / mol$$

$$RMM of disulphide = 2 \times 32.065 g / mol$$

$$( i )$$

$$Concentration of disulphide bonds in reactive diluent ( wt . \% ) = [ \text{} ( Number of disulphide bonds in reactive diluent \times RMM of disulphide ) / RMM of reactive diluent ] \times 100$$

$$( ii )$$

$$Concentration of disulphide bonds in crosslinker ( wt . \% ) = [ \text{} ( Number of disulphide bonds in crosslinker \times RMM of disulphide ) / RMM of crosslinker ] \times 100$$

$$( iii )$$

$$Concentration of disulphide bonds ( wt . \% ) in resin composition = ( Concentration of disulphide bonds in reactive diluent \times wt . \% of \text{} reactive diluent in resin composition ) + ( Concentration of disulphide bonds in crosslinker \times wt . \% of crosslinker in resin composition )$$

The resin composition according to the invention may have a concentration of disulphide bonds at least 10 wt. %.

In embodiments, the concentration of the disulphide bonds in the resin composition may be at least 10.5, 11, 11.5, 12, 12.5, 13, 13.5, 14, 14.5, 15, 15.5, 16, 16.5, 17, 17.5, or 18 wt. %. This is in contrast to the prior art wherein the concentration of the disulphide bonds in the resin composition is less than 10 wt. %. In embodiments, the concentration of the disulphide bonds in the resin composition is from 10 to 50 wt. %, or from 15 to 40 wt. %, or from 18 to 30 wt. %.

In embodiments, the molecular weight of the reactive diluent is not greater than, say, 600 gmol⁻¹, e.g. not greater than 550 gmol⁻¹, or not greater than 500 gmol⁻¹.

In embodiments, the molecular weight of the crosslinker is not greater than 1000 g mol⁻¹, e.g. not greater than 950 g mol⁻¹, or 900 g mol⁻¹, or 850 g mol⁻¹, or 800 g mol⁻¹, or 750 g mol⁻¹, or 700 g mol⁻¹. In embodiments, the molecular weight of the crosslinker is greater than 500 gmol⁻¹.

In embodiments, the molecular weight of the reactive diluent is less than the molecular weight of the crosslinker. In embodiments, the molecular weight of the crosslinker is less than the molecular weight of the reactive diluent.

The molecular weight is calculated using mass spectrometry.

In embodiments, the reactive diluent is a monomer molecule. In embodiments, the crosslinker is a monomer molecule. In this context, the term “monomer molecule” means a small, non-polymeric molecule, i.e. a molecule that does not comprise a polymeric component and/or a molecule that does not comprise multiple (for example greater than 2, 3 or 4) repeating units. The reactive diluent and/or crosslinker, e.g. the “monomer molecule”, may be a small molecule, for example having a molecular mass of less than 1000 g mol⁻¹. The “monomer molecule” may not be or comprise a macromolecule. For example, the term “macromolecule” according to the IUPAC definition is a molecule of high relative molecular mass, the structure of which essentially comprises the multiple repetition of units derived, actually or conceptually, from molecules of low relative molecular mass.

In embodiments, the reactive diluent and/or the crosslinker comprise no more than one, two, three, four, or five units of ethylene glycol (e.g. polyethylene glycol, PEG) in its structure. In embodiments, the reactive diluent and/or the crosslinker do not comprise any units of ethylene glycol, e.g. do not comprise any polyethylene glycol, in its structure. In embodiments, the reactive diluent and/or the crosslinker may not comprise or be a PEG polymer.

The resin composition according to the invention may comprise a reactive diluent and a crosslinker which each have one or more disulphide groups. In embodiments, the reactive diluent has fewer disulphide groups than the crosslinker. In embodiments, the reactive diluent has a single disulphide group, and the crosslinker has more than one disulphide group. In embodiments, the resin composition may comprise plural different cross linkers and/or plural different reactive diluents. Advantageously, this may afford fine tuning of mechanical properties of a so-formed cured resin.

It has been surprisingly found that a resin composition according to claim 1, wherein the concentration of the disulphide bonds is at least 10 wt. % and/or the reactive diluent has a low molecular weight of less than 600 gmol⁻¹ and/or the reactive diluent is a monomeric molecule leads to a high crosslinking density when the resin composition is photopolymerised into a 3D part. This is because there is a relatively high concentration of crosslinkable groups (i.e. disulphide groups) within the resin composition of the invention. In contrast, resin compositions of the prior art (e.g. using cyclic disulphides as recyclable photocurable resins) use high molecular weight macromonomers with relatively fewer disulphide bonds per gram of resin, which leads to a low concentration of crosslinkable groups within the resin composition. The high crosslinking density imparts a number of advantages to the resin composition of the invention. These advantages include the ability to rapidly print parts, e.g. 3D parts, from the resin composition of the invention, which makes it suitable for photopolymerisation, e.g. using DLP 3D printing. It has been surprisingly found that the resin composition is suitable for printing intricate 3D parts with excellent resolution and high fidelity. In addition, the resulting 3D printed parts made using the resin composition of the invention have excellent structural integrity and favourable thermomechanical properties. This sets the resulting 3D printed parts of the invention apart from the prior art, which led to soft, weak materials that poorly translated to 3D printing.

In embodiments, the crosslinker may comprise a fourth or n^{th} (e.g. fifth or sixth) cyclic disulphide group. Advantageously, this enables the crosslinking density to be further increased within the resulting part, e.g. 3D printed part, using the resin composition of the invention.

Advantageously, during curing, for example printing, e.g. 3D printing, the disulphide bonds of the reactive diluent molecules react with one another to form a linear disulphide backbone, and the crosslinker is able to crosslink the backbone to form a robust cured part.

In embodiments, the resin composition may comprise from 1.0 to 99.0 wt. % reactive diluent and from 99.0 to 1.0 wt. % crosslinker, for example from 5.0 wt. % to 95 wt. % reactive diluent and from 95.0 wt. % to 5.0 wt. % crosslinker, e.g. from 10.0 wt. % to 90 wt. % reactive diluent and from 90.0 wt. % to 10.0 wt. % crosslinker, or from 20.0 wt. % to 80 wt. % reactive diluent and from 80.0 wt. % to 20.0 wt. % crosslinker, or from 30.0 wt. % to 70 wt. % reactive diluent and from 70.0 wt. % to 30.0 wt. % crosslinker, or from 40.0 wt. % to 60 wt. % reactive diluent and from 60.0 wt. % to 40.0 wt. % crosslinker, or 50 wt. % reactive diluent and 50.0 wt. % crosslinker.

In embodiments, the resin composition may comprise the diluent, e.g. the non-reactive or reactive diluent, in an amount from any one of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 wt. %, to any one of 99, 98, 97, 96, 95, 94, 93, 92, 91, 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, 1 wt. %. In embodiments, the resin composition may comprise the reactive diluent in an amount from 10 to 90 wt. %, or 20 to 80 wt. %, or 30 to 80 wt. %, or 40 to 50 wt. % of the resin composition.

In embodiments, the resin composition may comprise the crosslinker in an amount from any one of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 wt. %, to any one of 99, 98, 97, 96, 95, 94, 93, 92, 91, 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, 1 wt. % of the resin composition. In embodiments, the resin composition may comprise the crosslinker in an amount from 10 to 90 wt. %, or 20 to 80 wt. %, or 30 to 80 wt. %, or 40 to 50 wt. % of the resin composition.

In embodiments, the resin composition may comprise a ratio of the diluent, e.g. the non-reactive or reactive diluent, to the crosslinker in 1:9 to 9:1, for example, 1:4 to 4:1 (i.e. 2:8 to 8:2), or 3:7 to 7:3, or 3:2 to 2:3 (i.e. 6:4 to 4:6), or 1:1 (i.e. 5:5). In embodiments, the resin composition may comprise a ratio of the reactive diluent to the crosslinker from any one of 1:9, 2:8, 3:7, 4:6, 5:5, 6:4, 7:3, 8:2, 9:1 to any one of 9:1, 8:2, 7:3, 6:4, 5:5, 4:6, 3:7, 2:8, 1:9.

In embodiments, the resin composition may comprise a ratio of the diluent, e.g. the non-reactive or reactive diluent, to the crosslinker in any one of 1:99, 2:98, 3:97, 4:96, 5:95, 6:94, 7:93, 8:92, 9:91, 10:90, 11:89, 12:88, 13:87, 14:86, 15:85, 16:84, 17:83, 18:82, 19:81, 20:80, 21:79, 22:78, 23:77, 24:76, 25:75, 26:74, 27:73, 28:72, 29:71, 30:70, 31:69, 32:68, 33:67, 34:66, 35:65, 36:64, 37:63, 38:62, 39:61, 40:60, 41:59, 42:58, 43:57, 44:56, 45:55, 46:54, 47:53, 48:52, 49:51, 50:50, 51:49, 52:48, 53:47, 54:46, 55:45, 56:44, 57:43, 58:42, 59:41, 60:40, 61:39, 62:38, 63:37, 64:36, 65:35, 66:34, 67:33, 68:32, 69:31, 70:30, 71:29, 72:28, 73:27, 74:26, 75:25, 76:24, 77:23, 78:22, 79:21, 80:20, 81:19, 82:18, 83:17, 84:16, 85:15, 86:14, 87:13, 88:12, 89:11, 90:10, 91:9, 92:8, 93:7, 94:6, 95:5, 96:4, 97:3, 98:2, 99:1.

Advantageously, the relative ratios of the diluent, e.g. the non-reactive or reactive diluent, to the crosslinker may be varied such that the overall crosslinking density may be controlled in the resulting crosslinked polymer, e.g. a 3D printed part. Most advantageously, this enables the thermomechanical properties of the polymer to be tuned, for example, depending on the application or use of the part, e.g. the 3D printed part.

In the compositions of the invention it is preferred to use a diluent, e.g. a non-reactive or reactive diluent, and it is most preferred to use a reactive diluent, with or without a non-reactive diluent.

In embodiments, the reactive diluent may have the following general structure:

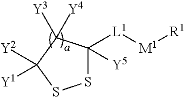

wherein a is selected from 1, 2, 3, 4, or 5;
Y¹, Y², Y³, Y⁴, Y⁵ are independently selected from H, D, F, Cl, Br, I, OH, C₁-C₄ alkoxy, C₂₋₆ alkenyl, C₁₋₆ haloalkyl, C₂₋₆ alkynyl, OR^{x}, NHR^{y}, NR^{y}R^{z} and R^{x}, R^{y}, and R^{z} are independently selected from H, C₁₋₆ alkyl, C₂₋₆ alkenyl, C₁₋₆ haloalkyl, C₂₋₆ alkynyl;
L¹ is selected from C₁₋₆ alkylene optionally substituted with one or more substituents independently selected from H, D, F, Cl, Br, I, OH, C₁-C₄ alkoxy, OR^{x}, NHR^{y}, NR^{y}R^{z}, and R^{x}, R^{y}, and R^{z} are independently selected from H, C₁₋₆ alkyl, C₂₋₆ alkenyl, C₁₋₆ haloalkyl, C₂₋₆ alkynyl;
M¹ is selected from O, —(C═O)—, —(C═O)—O—, —O—(C═O)—, —O—(C═O)—O—, N, —N—(C═O)—, —(C═O)—N—, —N—(C═O)—O—, —O—(C═O)—N—, —(N═C)—, —(C═O)—O—(C═O)—;
R¹ is selected from C₁₋₂₀ alkyl, C₂₋₂₀ alkenyl, C₁₋₂₀ haloalkyl, C₂₋₂₀ alkynyl, C₃₋₉ cycloalkyl, C₃₋₉ aryl, C₃₋₉ heteroaryl, C₃₋₉ heterocyclyl;
wherein R¹ is optionally substituted with one or more of H, D, F, Cl, Br, I, OH, C₁-C₄ alkoxy, C₂₋₆ alkenyl, C₁₋₆ haloalkyl, C₂₋₆ alkynyl, OR^{x}, NHR^{y}, NR^{y}R^{z} and R^{x}, R^{y}, and R^{z} are independently selected from H, C₁₋₆ alkyl, C₂₋₆ alkenyl, C₁₋₆ haloalkyl, C₂₋₆ alkynyl.

In embodiments, a is 1, 2, 3, 4, or 5, i.e. the first cyclic disulphide group of the reactive diluent may be selected from one of a five, six, seven, eight, or nine membered ring. In some embodiments, a is 1 or 2. Preferably, a=1, i.e. the first cyclic disulphide group of the reactive diluent is a five membered ring e.g. a 1,2-dithiolane. Advantageously, a five membered disulphide ring has larger ring strain than say a six membered ring, thereby driving the polymerisation process to be more rapid and complete.

In embodiments, the crosslinker may have the following general structure:

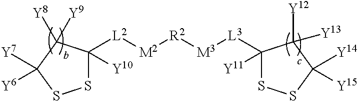

wherein b and c are independently selected from 1, 2, 3, 4, or 5;
Y⁶, Y⁷, Y⁸, Y⁹, Y¹⁰, Y¹¹, Y¹², Y¹³, Y¹⁴, Y¹⁵ are independently selected from H, D, F, Cl, Br, I, OH, C₁-C₄ alkoxy, C₂₋₆ alkenyl, C₁₋₆ haloalkyl, C₂₋₆ alkynyl, OR^{x}, NHR^{y}, NR^{y}R^{z} and R^{x}, R^{y}, and R^{z} are independently selected from H, C₁₋₆ alkyl, C₂₋₆ alkenyl, C₁₋₆ haloalkyl, C₂₋₆ alkynyl;
L² and L³ are independently selected from C₁₋₆ alkylene optionally substituted with one or more substituents independently selected from H, D, F, Cl, Br, I, OH, C₁-C₄ alkoxy, OR^{x}, NHR^{y}, NR^{y}R^{z}, and R^{x}, R^{y}, and R^{z} are independently selected from H, C₁₋₆ alkyl, C₂₋₆ alkenyl, C₁₋₆ haloalkyl, C₂₋₆ alkynyl;
M² and M³ is independently selected from O, —(C═O)—, —(C═O)—O—, —O—(C═O)—, —O—(C═O)—O—, N, —N—(C═O)—, —(C═O)—N—, —N—(C═O)—O—, —O—(C═O)—N—, —(N═C)—, —(C═O)—O—(C═O)—;
R² is selected from C₁₋₂₀ alkylene, C₂₋₂₀ alkenyl, C₁₋₂₀ haloalkyl, C₂₋₂₀ alkynyl, C₃₋₉ cycloalkyl, C₃₋₉ aryl, C₃₋₉ heteroaryl, C₃₋₉ heterocyclyl;
wherein R² is optionally substituted with one or more of H, D, F, Cl, Br, I, OH, C₁-C₄ alkoxy, C₂₋₆ alkenyl, C₁₋₆ haloalkyl, C₂₋₆ alkynyl, OR^{x}, NHR^{y}, NR^{y}R^{z} and R^{x}, R^{y}, and R^{z} are independently selected from H, C₁₋₆ alkyl, C₂₋₆ alkenyl, C₁₋₆ haloalkyl, C₂₋₆ alkynyl.

Preferably, b and c are each 1.

In embodiments, L² and/or L³ is C₁₋₆ alkylene, e.g. an unsubstituted C₁₋₆ alkylene. In embodiments, L² and L³ is C₄ alkylene, e.g. C₄H₈.

In embodiments, the crosslinker has the following general structure:

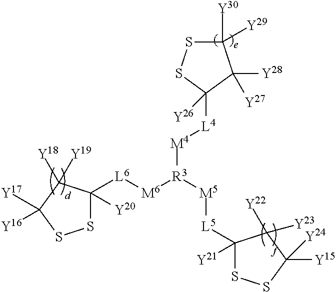

wherein d, e, and f are independently selected from 1, 2, 3, 4, or 5;
Y¹⁶, Y¹⁷, Y¹⁸, Y¹⁹, Y²⁰, Y²¹, Y², Y²³, Y²⁴, Y²⁵, Y²⁶, Y²⁷, Y²⁸, Y²⁹, Y³⁰ are independently selected from H, D, F, Cl, Br, I, OH, C₁-C₄ alkoxy, C₂₋₆ alkenyl, C₁₋₆ haloalkyl, C₂₋₆ alkynyl, OR^{x}, NHR^{y}, NR^{y}R^{z} and R^{x}, R^{y}, and R^{z} are independently selected from H, C₁₋₆ alkyl, C₂₋₆ alkenyl, C₁₋₆ haloalkyl, C₂₋₆ alkynyl;
L⁴, L⁵, and L⁶ are independently selected from C₁₋₆ alkylene optionally substituted with one or more substituents independently selected from H, D, F, Cl, Br, I, OH, C₁-C₄ alkoxy, OR^{x}, NHR^{y}, NR^{y}R^{z}, and R^{x}, R^{y}, and R^{z} are independently selected from H, C₁₋₆ alkyl, C₂₋₆ alkenyl, C₁₋₆ haloalkyl, C₂₋₆ alkynyl;
M⁴, M⁵, and M⁶ is independently selected from O, —(C═O)—, —(C═O)—O—, —O—(C═O)—, —O—(C═O)—O—, N, —N—(C═O)—, —(C═O)—N—, —N—(C═O)—O—, —O—(C═O)—N—, —(—N═C—)—, —(C═O)—O—(C═O)—;
R³ selected from C₁₋₂₀ alkylene, C₂₋₂₀ alkenyl, C₁₋₂₀ haloalkyl, C₂₋₂₀ alkynyl, C₃₋₉ cycloalkyl, C₃₋₉ aryl, C₃₋₉ heteroaryl, C₃₋₉ heterocyclyl;
wherein R³ is optionally substituted with one or more of H, D, F, Cl, Br, I, OH, C₁-C₄ alkoxy, C₂₋₆ alkenyl, C₁₋₆ haloalkyl, C₂₋₆ alkynyl, OR^{x}, NHR^{y}, NR^{y}R^{z} and R^{x}, R^{y}, and R^{z} are independently selected from H, C₁₋₆ alkyl, C₂₋₆ alkenyl, C₁₋₆ haloalkyl, C₂₋₆ alkynyl.

Preferably, d, e, and f are each 1.

In embodiments, one or both of the second cyclic disulphide group and/or the third cyclic disulphide group of the crosslinker may be selected from one of a five, six, seven, eight, or nine membered ring. In embodiments, one or both of the second cyclic disulphide group and/or the third cyclic disulphide group of the crosslinker may be a five membered ring, e.g. a 1,2-dithiolane. Advantageously, a five membered disulphide ring has larger ring strain than say a six membered ring, thereby driving the polymerisation process to be more rapid and complete.

In embodiments, the reactive diluent may have the following general structure:

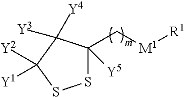

wherein Y¹, Y², Y³, Y⁴, Y⁵ are defined as above;
m is selected from 1, 2, 3, 4, 5, 6;
M¹ is defined as above;
R¹ is defined as above.

In embodiments, Y¹, Y², Y³, Y⁴, Y⁵ are H.

In embodiments, m is 4.

In embodiments, M¹ is —(C═O)—O—.

In embodiments, R¹ is C₁₋₂₀ alkyl. R¹ may be selected from (i) to (vi):

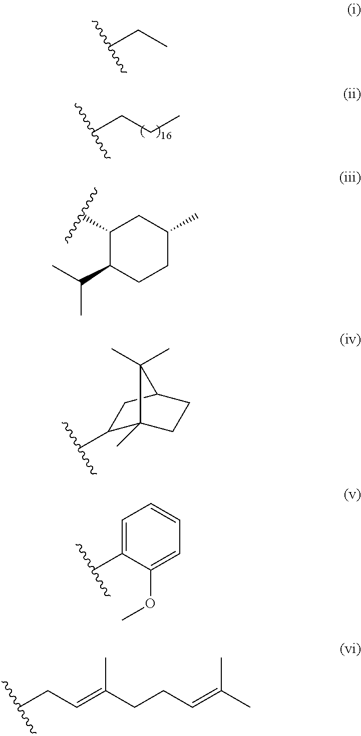

In embodiments, the crosslinker may have the following general structure:

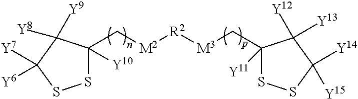

wherein Y⁶, Y⁷, Y⁸, Y⁹, Y¹⁰, Y¹¹, Y¹², Y¹³, Y¹⁴, Y¹⁵ are defined as above;
n and p are independently selected from 1, 2, 3, 4, 5, 6;
M² and M³ are defined as above;
R² is defined as above.

In embodiments, Y⁶, Y⁷, Y⁸, Y⁸, Y¹⁰, Y¹¹, Y¹², Y¹³, Y¹⁴, Y¹⁵ are H.

In embodiments, n and p are each 4.

In embodiments, M² and/or M³ are —(C═O)—O—.

In embodiments, R² is C₃₋₉ heterocycly. In embodiments, R² is (vii):

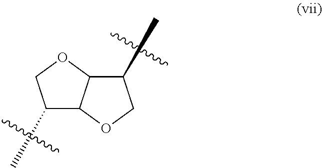

In embodiments, the crosslinker may have the following general structure:

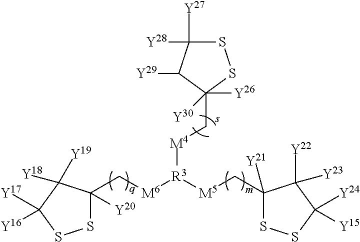

wherein Y¹⁶, Y¹⁷, Y¹⁸, Y¹⁸, Y²⁰, Y²¹, Y²², Y²³, Y²⁴, Y²⁵, Y²⁸, Y²⁷, Y²⁸, Y²⁸, Y³⁰ are defined as above;
q, r, and s are independently selected from 1, 2, 3, 4, 5, 6;
L⁴, L⁵, and L⁶ are defined as above;
M⁴, M⁵, and M⁸ are defined as above;
R³ is defined as above.

In embodiments, Y¹⁶, Y¹⁷, Y¹⁸, Y¹⁹, Y²⁰, Y²¹, Y², Y²³, Y²⁴, Y²⁵, Y²⁶, Y²⁷, Y²⁸, Y²⁸, Y³⁰ are H.

In embodiments, q, r, and s are each 4.

In embodiments, M⁴ and/or M⁵ and/or M⁶ is —(C═O)—O—.

In embodiments, R³ is C₁₋₂₀ alkylene. In embodiments, R³ is (viii).

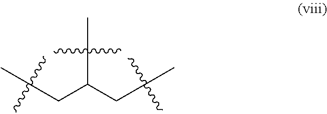 [SMILES: *CC(*)C*]

The term Cₘ₋ₙ refers to a group with m to n carbon atoms.

The term “C₁₋₂₀ alkyl” refers to a linear or branched hydrocarbon chain containing 1, 2, 3, 4, 5, 6, 7, 8, 9, 10, 11, 12, 13, 14, 15, 16, 17, 18, 19, or 20 carbon atoms, for example methyl, ethyl, n-propyl, iso-propyl, n-butyl, iso-butyl, sec-butyl, tert-butyl, n-pentyl and n-hexyl, n-heptyl, n-octyl, n-decyl, n-decyl, n-undecyl, n-dodecyl, n-tridecyl, n-tetradecyl, n-pentadecyl, n-hexadecyl, n-heptadecyl, n-octadecyl, n-nonadecyl, or n-eicosyl, and so on.

The term “C₂₋₂₀ alkylene” refers to a divalent alkyl group, which is a linear or branched hydrocarbon chain containing 2, 3, 4, 5, 6, 7, 8, 9, 10, 11, 12, 13, 14, 15, 16, 17, 18, 19, or carbon atoms. Alkylene groups are divalent alkyl groups and may likewise be linear or branched and have two points of attachment to the remainder of the molecule. Furthermore, an alkylene group may, for example, correspond to one of those alkyl groups listed in this paragraph. For example, C₁₋₆ alkylene may be —CH₂—, —CH₂CH₂—, —CH₂CH(CH₃)—, —CH₂CH₂CH₂— or —CH₂CH(CH₃)CH₂—. The alkyl and alkylene groups may be unsubstituted or substituted by one or more substituents. Possible substituents are described herein. For example, substituents for an alkyl or alkylene group may be halogen, e.g. fluorine, chlorine, bromine and iodine, OH, C₁-C₄ alkoxy, —NR′R″ amino, wherein R′ and R″ are independently H or alkyl, e.g. C₁₋₆ alkyl. Substituents may also be ring systems such as an aromatic ring (e.g. a five or six membered aromatic ring), a saturated ring system (e.g. a five or six membered saturated ring system), a bridged ring system, a spiro bicyclic ring system, or a heterocyclic ring system. The ring system may itself be substituted or unsubstituted. Other substituents for the alkyl group may alternatively be used.

The term “C₂₋₂₀ alkenyl” refers to a linear or branched hydrocarbon chain containing at least one double bond and having 2, 3, 4, 5, 6, 7, 8, 9, 10, 11, 12, 13, 14, 15, 16, 17, 18, 19, or carbon atoms. The double bond(s) may be present as the E or Z isomer. The double bond may be at any possible position of the hydrocarbon chain. For example, a “C₂₋₆ alkenyl” may be ethenyl, propenyl, butenyl, butadienyl, pentenyl, pentadienyl, hexenyl and hexadienyl. Alkenylene groups are divalent alkenyl groups and may likewise be linear or branched and have two points of attachment to the remainder of the molecule. Furthermore, an alkenylene group may, for example, correspond to one of those alkenyl groups listed in this paragraph. For example alkenylene may be —CH═CH—, —CH₂CH═CH—, —CH(CH₃)CH═CH— or —CH₂CH═CH—. Alkenyl and alkenylene groups may unsubstituted or substituted by one or more substituents. Possible substituents are described herein. For example, substituents may be those described above as substituents for alkyl groups.

The term “C₁₋₂₀ haloalkyl”, e.g. “C₁₋₄ haloalkyl”, refers to a hydrocarbon chain substituted with at least one halogen atom independently chosen at each occurrence, for example fluorine, chlorine, bromine and iodine. The halogen atom may be present at any position on the hydrocarbon chain. For example, C₁₋₆ haloalkyl may refer to chloromethyl, fluoromethyl, trifluoromethyl, chloroethyl e.g. 1-chloromethyl and 2-chloroethyl, trichloroethyl e.g. 1,2,2-trichloroethyl, 2,2,2-trichloroethyl, fluoroethyl e.g. 1-fluoromethyl and 2-fluoroethyl, trifluoroethyl e.g. 1,2,2-trifluoroethyl and 2,2,2-trifluoroethyl, chloropropyl, trichloropropyl, fluoropropyl, trifluoropropyl. A haloalkyl group may be, for example, —CX₃, —CHX₂, —CH₂CX₃, —CH₂CHX₂ or —CX(CH₃)CH₃ wherein X is a halo (e.g. F, Cl, Br or I). A fluoroalkyl group, i.e. a hydrocarbon chain substituted with at least one fluorine atom (e.g. —CF₃, —CHF₂, —CH₂CF₃ or —CH₂CHF₂).

The term “C₂₋₂₀ alkynyl” includes a branched or linear hydrocarbon chain containing at least one triple bond and having 2, 3, 4, 5, 6, 7, 8, 9, 10, 11, 12, 13, 14, 15, 16, 17, 18, 19, or 20 carbon atoms. The triple bond may be at any possible position of the hydrocarbon chain. For example, the “C₂₋₆ alkynyl” may be ethynyl, propynyl, butynyl, pentynyl and hexynyl. Alkynylene groups are divalent alkynyl groups and may likewise be linear or branched and have two points of attachment to the remainder of the molecule. Furthermore, an alkynylene group may, for example, correspond to one of those alkynyl groups listed in this paragraph. For example alkynylene may be —C≡C—, —CH₂C≡C—, —CH₂C≡CCH₂—, —CH(CH₃)CH≡C— or —CH₂C≡CCH₃. Alkynyl and alkynylene groups may unsubstituted or substituted by one or more substituents. Possible substituents are described herein. For example, substituents may be those described above as substituents for alkyl groups.

The term “C₃₋₉ cycloalkyl” includes a saturated hydrocarbon ring system containing 3, 4, 5, 6, 7, 8, or 9 carbon atoms. For example, the “C₃-C₆ cycloalkyl” may be cyclopropyl, cyclobutyl, cyclopentyl, cyclohexyl, bicyclo[2.1.1]hexane or bicyclo[1.1.1]pentane. Suitably the “C₃-C₆ cycloalkyl” may be cyclopropyl, cyclobutyl, cyclopentyl or cyclohexyl.

The term “aromatic” when applied to a substituent as a whole includes a single ring or polycyclic ring system with 4n+2 electrons in a conjugated π system within the ring or ring system where all atoms contributing to the conjugated π system are in the same plane.

The term “aryl” includes an aromatic hydrocarbon ring system. The ring system has 4n+2 electrons in a conjugated π system within a ring where all atoms contributing to the conjugated π system are in the same plane. For example, the “aryl” may be phenyl and naphthyl. The aryl system itself may be substituted with other groups.

The term “heteroaryl” includes an aromatic mono- or bicyclic ring incorporating one or more (for example 1-4, particularly 1, 2 or 3) heteroatoms selected from nitrogen, oxygen or sulfur. The ring or ring system has 4n+2 electrons in a conjugated π system where all atoms contributing to the conjugated π system are in the same plane.

The term “heterocyclic” includes a non-aromatic saturated or partially saturated monocyclic or fused, bridged, or spiro bicyclic heterocyclic ring system. Monocyclic heterocyclic rings may contain from about 3 to 12 (suitably from 3 to 7) ring atoms, with from 1 to 5 (suitably 1, 2 or 3) heteroatoms selected from nitrogen, oxygen or sulfur in the ring. Bicyclic heterocycles may contain from 7 to 12-member atoms in the ring. Bicyclic heterocyclic(s) rings may be fused, spiro, or bridged ring systems. The heterocyclyl group may be a 3-12, for example, a 3- to 9- (e.g. a 3- to 7-) membered non-aromatic monocyclic or bicyclic saturated or partially saturated group comprising 1, 2 or 3 heteroatoms independently selected from O, S and N in the ring system (in other words 1, 2 or 3 of the atoms forming the ring system are selected from O, S and N). By partially saturated it is meant that the ring may comprise one or two double bonds. This applies particularly to monocyclic rings with from 5 to 7 members. The double bond will typically be between two carbon atoms but may be between a carbon atom and a nitrogen atom. Bicyclic systems may be spiro-fused, i.e. where the rings are linked to each other through a single carbon atom; vicinally fused, i.e. where the rings are linked to each other through two adjacent carbon and/or nitrogen atoms; or they may be share a bridgehead, i.e. the rings are linked to each other through two non-adjacent carbon or nitrogen atoms (a bridged ring system). Examples of heterocyclic groups include cyclic ethers such as oxiranyl, oxetanyl, tetrahydrofuranyl, dioxanyl, and substituted cyclic ethers. Heterocycles comprising at least one nitrogen in a ring position include, for example, azetidinyl, pyrrolidinyl, piperidinyl, piperazinyl, morpholinyl, thiomorpholinyl, tetrahydrotriazinyl, tetrahydropyrazolyl, tetrahydropyridinyl, homopiperidinyl, homopiperazinyl, 2,5-diaza-bicyclo[2.2.1]heptanyl and the like. Typical sulfur containing heterocycles include tetrahydrothienyl, dihydro-1,3-dithiol, tetrahydro-2H-thiopyran, and hexahydrothiepine. Other heterocycles include dihydro oxathiolyl, tetrahydro oxazolyl, tetrahydro-oxadiazolyl, tetrahydrodioxazolyl, tetrahydrooxathiazolyl, hexahydrotriazinyl, tetrahydro oxazinyl, tetrahydropyrimidinyl, dioxolinyl, octahydrobenzofuranyl, octahydrobenzimidazolyl, and octahydrobenzothiazolyl. For heterocycles containing sulfur, the oxidized sulfur heterocycles containing SO or SO₂ groups are also included. Examples include the sulfoxide and sulfone forms of tetrahydrothienyl and thiomorpholinyl such as tetrahydrothiene 1,1-dioxide and thiomorpholinyl 1,1-dioxide. A suitable value for a heterocyclyl group which bears 1 or 2 oxo (═O), for example, 2 oxopyrrolidinyl, 2-oxoimidazolidinyl, 2-oxopiperidinyl, 2,5-dioxopyrrolidinyl, 2,5-dioxoimidazolidinyl or 2,6-dioxopiperidinyl. Particular heterocyclyl groups are saturated monocyclic 3 to 7 membered heterocyclyls containing 1, 2 or 3 heteroatoms selected from nitrogen, oxygen or sulfur, for example azetidinyl, tetrahydrofuranyl, tetrahydropyranyl, pyrrolidinyl, morpholinyl, tetrahydrothienyl, tetrahydrothienyl 1,1-dioxide, thiomorpholinyl, thiomorpholinyl 1,1-dioxide, piperidinyl, homopiperidinyl, piperazinyl or homopiperazinyl. As the skilled person would appreciate, any heterocycle may be linked to another group via any suitable atom, such as via a carbon or nitrogen atom. For example, the term “piperidino” or “morpholino” refers to a piperidin-1-yl or morpholin-4-yl ring that is linked via the ring nitrogen.

The term “fused ring system” takes the IUPAC definition and includes aliphatic and aromatic systems.

The term “bridged ring systems” includes ring systems in which two rings share more than two atoms, see for example Advanced Organic Chemistry, by Jerry March, 4th Edition, Wiley Interscience, pages 131-133, 1992. Suitably the bridge is formed between two non-adjacent carbon or nitrogen atoms in the ring system. The bridge connecting the bridgehead atoms may be a bond or comprise one or more atoms. Examples of bridged heterocyclyl ring include, systems aza-bicyclo[2.2.1]heptane, 2-oxa-5-azabicyclo[2.2.1]heptane, aza-bicyclo[2.2.2]octane, aza-bicyclo[3.2.1]octane, and quinuclidine.

The term “spiro bi-cyclic ring systems” includes ring systems in which two ring systems share one common spiro carbon atom, i.e. the heterocyclic ring is linked to a further carbocyclic or heterocyclic ring through a single common spiro carbon atom. Examples of spiro ring systems include 3,8-diaza-bicyclo[3.2.1]octane, 2,5-diaza-bicyclo[2.2.1]heptane, 6-azaspiro[3.4]octane, 2-oxa-6-azaspiro[3.4]octane, 2-azaspiro[3.3]heptane, 2-oxa-6-azaspiro[3.3]heptane, 6-oxa-2-azaspiro[3.4]octane, 2,7-diaza-spiro[4.4]nonane, 2-azaspiro[3.5]nonane, 2-oxa-7-azaspiro[3.5]nonane and 2-oxa-6-azaspiro[3.5]nonane.

In embodiments, an alkene group within the resin composition (e.g. which is part of the reactive diluent or the crosslinker) may be electron-poor. In embodiments, an alkene group within the resin composition may form part of a diene or triene. In embodiments, an alkene group within the resin composition may be a tri-substituted alkene, or a tetra-substituted alkene. In embodiments, the alkene may not be or comprise an acrylate group or moiety. In embodiments, the resin composition (e.g. the reactive diluent and/or the crosslinker) may not comprise an alkene.

In embodiments, an alkyne group within the resin composition (e.g. which is part of the reactive diluent or the crosslinker) may be electron-poor. In embodiments, the alkyne group within the resin composition may be a terminal alkyne. In embodiments, the resin composition (e.g. the reactive diluent and/or the crosslinker) may not comprise an alkyne.

Whilst we prefer not to have alkene or alkyne groups in the cross linker (and/or in the reactive diluent), it may be possible to include these moieties, especially if they do not cross link during the curing process, which would likely interfere with the depolymerisability of the cured resin.

However, if depolymerisation is not an issue, alkene and alkyne groups, including acrylates, may be included.

In embodiments, one or both of the reactive diluent and/or the crosslinker is a derivative, e.g. an ester, of lipoic acid.

In embodiments, the reactive diluent is a reaction product of a reaction between lipoic acid (e.g. or a derivative thereof) and an alcohol. In embodiments, the alcohol may be a naturally occurring alcohol and/or derivable from a renewable source. In embodiments, the alcohol may be selected from one of ethanol, 1-octadecanaol, menthol, isoborneol, guaiacol, or geraniol.

In embodiments, the reactive diluent be selected from one or more of the following compounds:

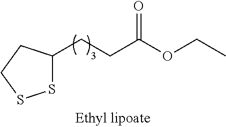

In embodiments, the crosslinker may be a reaction product of a reaction between lipoic acid (e.g. or a derivative thereof) and a diol or a triol. In embodiments, the diol or triol may be a naturally occurring alcohol and/or derivable from a renewable source. In embodiments, the diol or triol may be selected from one of isosorbitol or glycerol.

In embodiments, the crosslinker be selected from one or more of the following compounds:

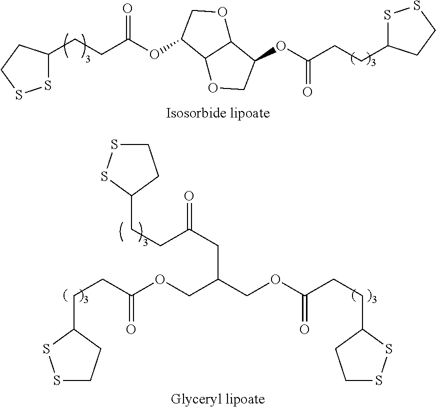

Although we have shown a crosslinker derived from isosorbide, it may also be derived from isomers such as isomannide and/or isoidide to form the corresponding lipoates.

Advantageously, both the reactive diluent and the crosslinker according to the invention may be non-toxic and renewable.

In embodiments, the resin composition may contain more than one reactive diluent, e.g. two, three, four, or more different reactive diluents. In embodiments, the resin composition may contain more than one crosslinker, e.g. two, three, four, or more different crosslinkers. In embodiments, the resin composition may consist of one or more (e.g. two, three, or more) reactive diluents, and one or more (e.g. two, three, or more) crosslinkers. In this application, reference to “the reactive diluent” in the resin composition may refer to only one type of reactive diluent, or may refer collectively to more than one type of reactive diluent, e.g. two or more reactive diluents with different molecular structures. Similarly, reference to “the crosslinker” in the resin composition may refer to only one type of crosslinker, or may refer collectively to more than one type of crosslinker, e.g. two or more crosslinkers with different molecular structures.

Advantageously, the properties of the resin composition and the resulting 3D printed part may be varied by varying the structures, amounts, types, and combinations of reactive diluents and/or crosslinkers.

In embodiments, the resin composition may comprise one or more photoinitiator(s), for example, a free radical photoinitiator. It will be appreciated that the choice of photoinitiator is dependent upon the wavelength of light used to cure the resin composition. In embodiments, the resin composition may comprise TPOL (ethyl phenyl (2,4,6-trimethylbenzoyl)phosphinate (CAS number: 84434-11-7). The photoinitiator TPOL may be cured with 300-405 nm light. However, the photoinitiator is not limited to TPOL and other suitable photoinitiators may be used that are known to the skilled person and may be found, for example, in the review article “Recent Trends in Advanced Photoinitiators for Vat Photopolymerization 3D Printing” in Macromolecular Rapid Communications, Vol. 43, Issue 14.

In embodiments, the resin composition may or may not comprise a photoinitiator.

Advantageously, for thin parts, or parts formed using a succession of relatively thin layers (e.g. <200 or <100 μm), we have surprisingly found that it is not necessary to include a photoinitiator. Conversely, when forming thicker parts (e.g. >0.25 mm) a photoinitiator can be added to improve cure rates and/or to increase cure depth.

A further aspect of the invention provides a method of fabricating a crosslinked polymer from the photocurable resin composition according to the invention, the method comprising exposing the photocurable resin composition to UV light, e.g. 300-500 nm, or 300-405 nm, for example using DLP (digital light processing).

Advantageously, the resin composition according to the invention may be used to print 3D parts using digital light processing (DLP).

A yet further aspect of the invention provides a crosslinked polymer fabricated from the photocurable resin composition according to the invention.

The resin composition for use in the method or to provide a crosslinked polymer may have any of the previously described additional features of the resin composition according to the invention.

In embodiments, the reactive diluent and/or the crosslinker do/does not comprise an acrylate bond. By the term “acrylate bond” we mean a linkage made from an acrylate group including methacrylate, ethacrylate, butyl acrylate, and derivatives thereof. In embodiments, the 3D printed part fabricated from the resin composition may be bonded and/or crosslinked using only disulphide bonds, i.e. the 3D part fabricated from the resin composition may have monomer linkages and/or crosslinkages that consist of disulphide bonds. Advantageously, this enables the resulting 3D printed part to be fully depolymerised. More advantageously, the resin composition and resulting 3D part comprise non-toxic linkages only.

A yet further aspect of the invention provides an article fabricated from the crosslinked polymer of the invention.

A yet further aspect of the invention provides a method of depolymerising the crosslinked polymer according to the invention, the method comprising contacting the crosslinked polymer with an organic base and a thiol.

A yet further aspect of the invention provides a method of depolymerising a crosslinked polymer comprising disulphide linkages or bonds, wherein the polymer does not comprise one or more acrylate linkages or bonds, the method comprising contacting the crosslinked polymer with an organic base and a thiol, e.g. to obtain monomer units (e.g. a reactive diluent and a crosslinker).

By the term “acrylate bond” we mean a linkage made from an acrylate group including methacrylate, ethacrylate, butyl acrylate, and derivatives thereof.

In embodiments, the organic base may be a non-nucleophilic strong base (e.g, wherein the pka of the conjugate acid is greater than or equal to 10) such as an amine, amidine, guanidine, or phosphazene (—P═N— bond). In embodiments, the organic base may be selected from one or more of tert-butylimino-tris(dimethylamino)phosphorane (CAS number: 81675-81-2), diazabicyclo[5.4.0]undec-7-ene (DBU) (CAS number: 6674-22-2), and/or triethylamine (CAS number: 121-44-8).

In embodiments, the thiol may be an aryl thiol, e.g. thiophenol.

In embodiments, the method may comprise heating the crosslinked polymer with the organic base and the thiol, for example to a temperature of greater than or equal to 40° C., or greater than or equal to 50° C., or greater than or equal to 60° C., for example greater than or equal to 70° C., or greater than or equal to 80° C.

In embodiments, the method may comprise forming monomer units from the crosslinked polymer, and subsequently polymerising the monomer units to form a crosslinked polymer, the method comprising exposing the monomer units to UV light, e.g. 300-500 nm, or 300-405 nm, for example using DLP (digital light processing).

A further aspect of the invention provides a method of repolymerising the monomer units obtained from the method of depolymerising a crosslinked polymer, the method comprising exposing the monomer units to UV light, e.g. 300-500 nm, or 300-405 nm, for example using DLP (digital light processing).

Advantageously, the crosslinked polymer of the invention can be efficiently catalytically depolymerized (c.a. 90% recovery) to regenerate a reactive resin which can be repeatedly 3D printed in a closed-loop manner. A closed-loop (circular) resin system for DLP-based printing has not been demonstrated in any prior state-of-the-art. Most advantageously, unlike crosslinking using methacrylate groups, the crosslinks created by the cyclic disulphide groups are reversible. This means that the printed parts can be efficiently depolymerized back into the original resin, which is then suitable to be recured and thus demonstrates closed-loop (circular) recyclability.

Advantageously, the resin composition of the invention has many of the advantages of commercially available methacrylate resins, but with other advantages such as low toxicity, sustainability, and recyclability.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

Embodiments of the invention will now be described by way of example only with reference to the accompanying drawings in which:

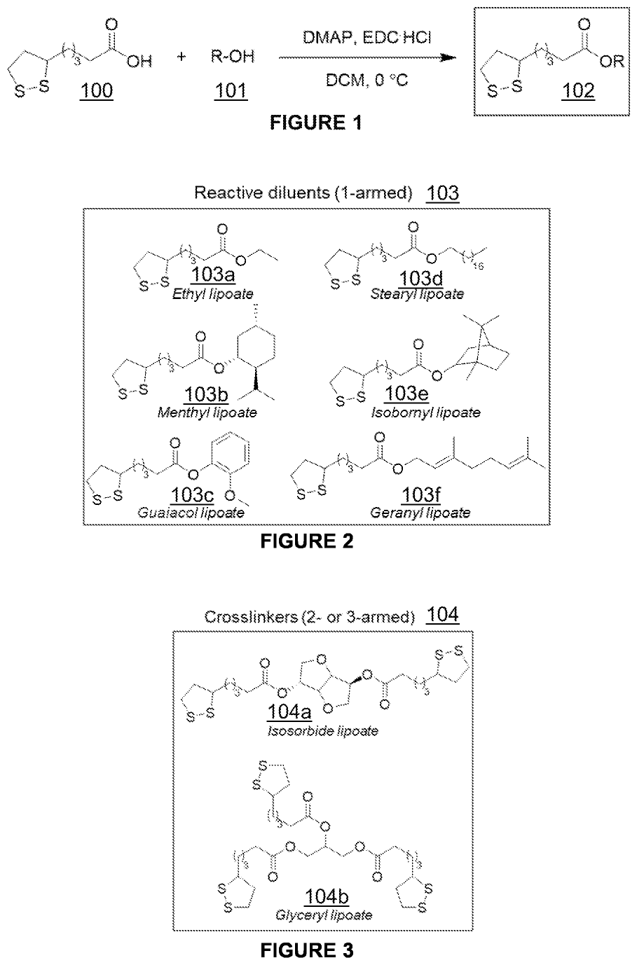

FIG. 1 is a reaction scheme for the synthesis of lipoates for use as reactive diluents and crosslinkers in the resin composition of the invention;

FIG. 2 shows Examples of reactive diluents for use in the resin composition of the invention;

FIG. 3 shows Examples of crosslinkers for use in the resin composition of the invention;

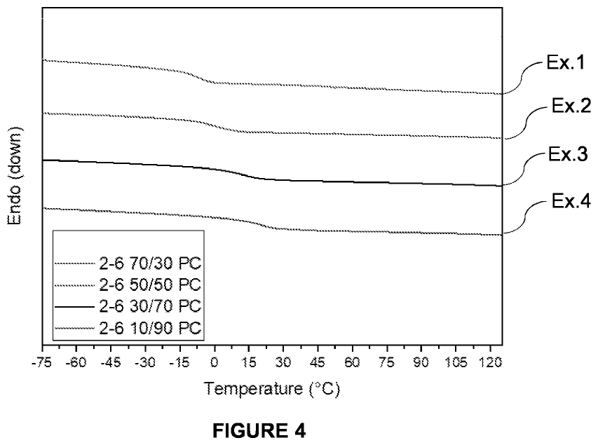

FIG. 4 is a Differential Scanning calorimetry (DSC) thermogram comparing 2D photosets from resin compositions of Examples 1 to 4 of the invention;

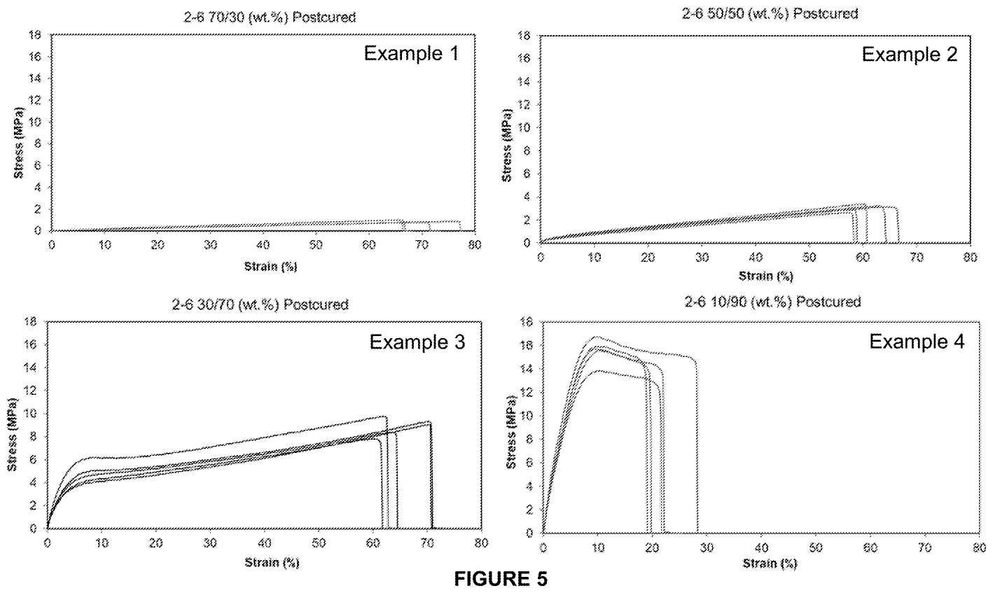

FIG. 5 is a series of graphs showing tensile testing comparing 2D photosets from resin compositions of Examples 1 to 4 of the invention;

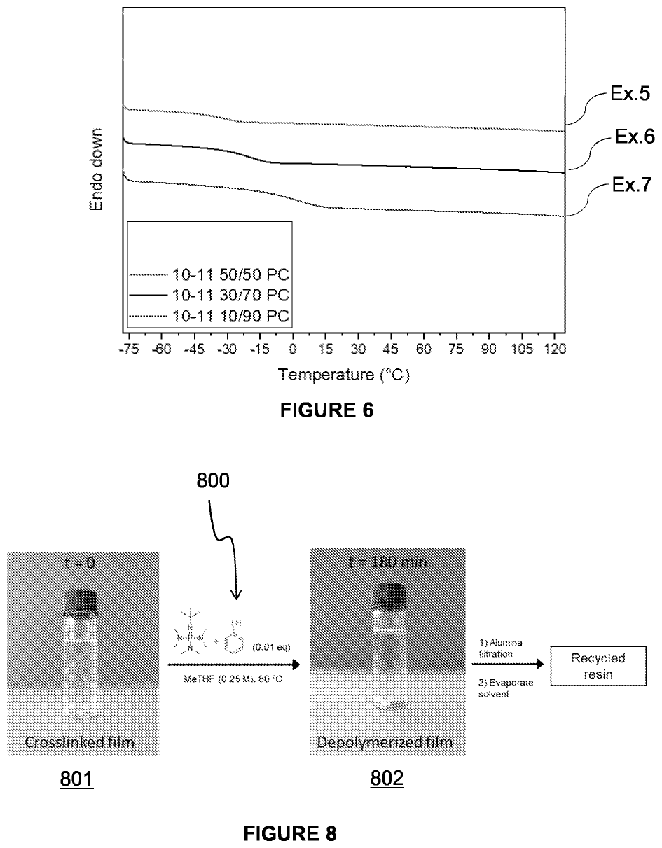

FIG. 6 is a Differential Scanning calorimetry (DSC) thermogram comparing 2D photosets from resin compositions of Examples 5 to 7;

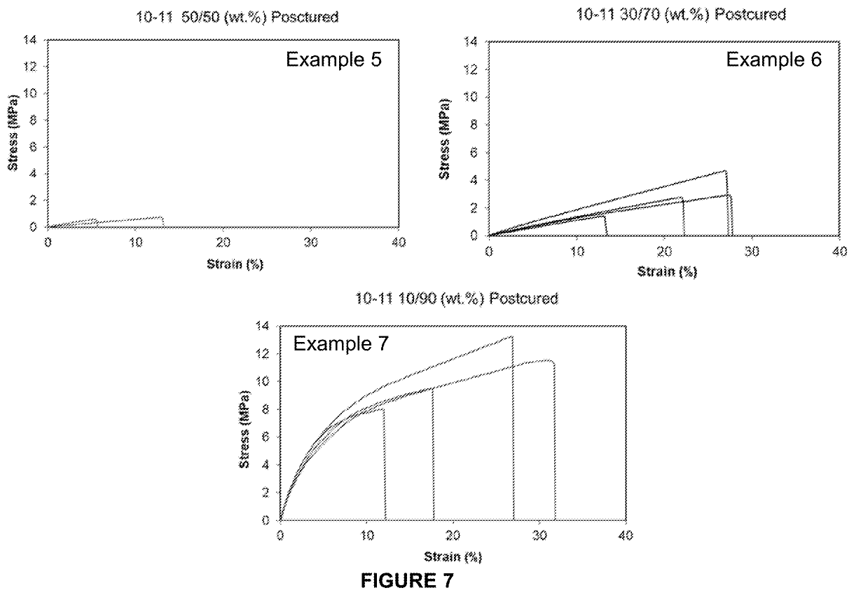

FIG. 7 is a series of graphs showing tensile testing comparing 2D photosets from resin compositions of Examples 5 to 7;

FIG. 8 is a reaction scheme for depolymerisation of a 2D photoset crosslinked film of Example 3;

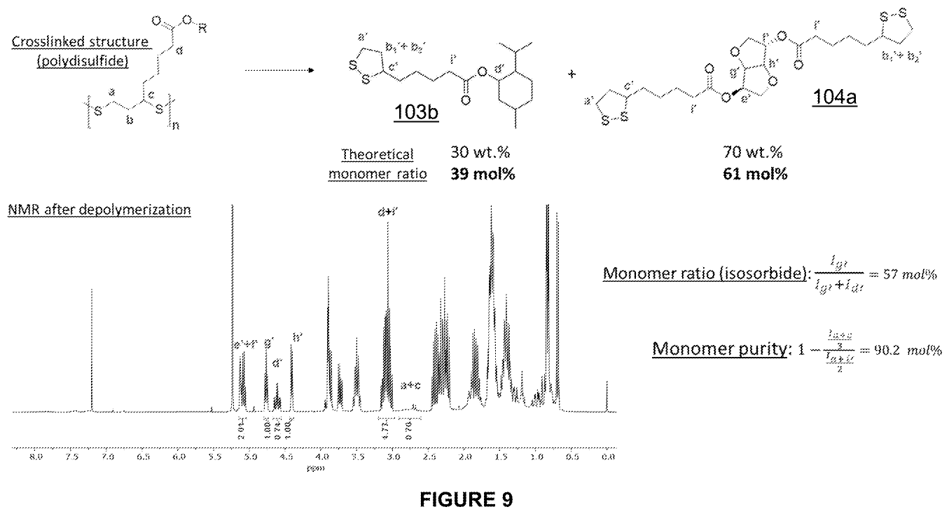

FIG. 9 is an 1H NMR spectrum of the depolymerised resin of Example 3;

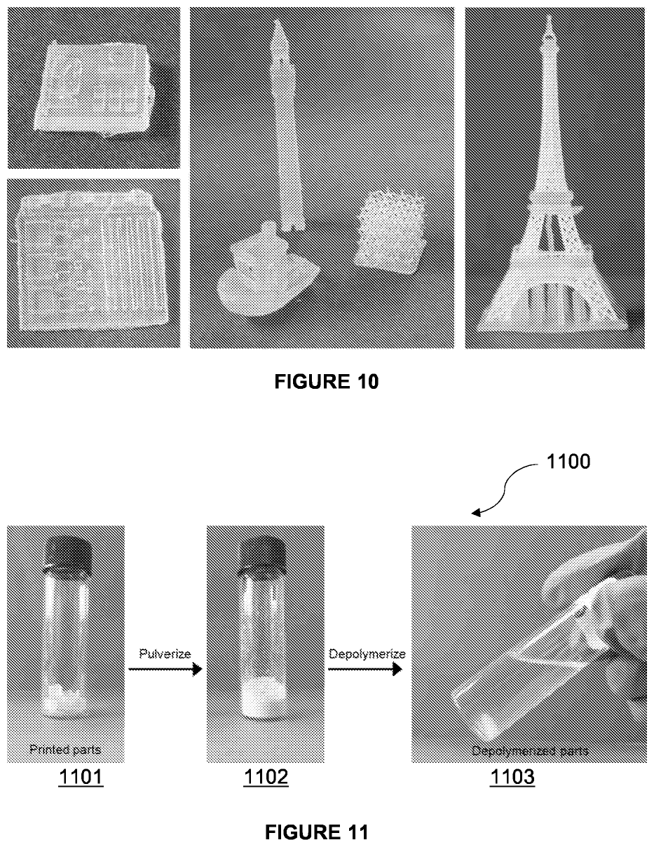

FIG. 10 there is shown a selection of 3D printed parts using the resin composition of the invention;

FIG. 11 is a reaction scheme for depolymerisation of the 3D printed part shown in FIG. 10 from the resin composition of Example 6;

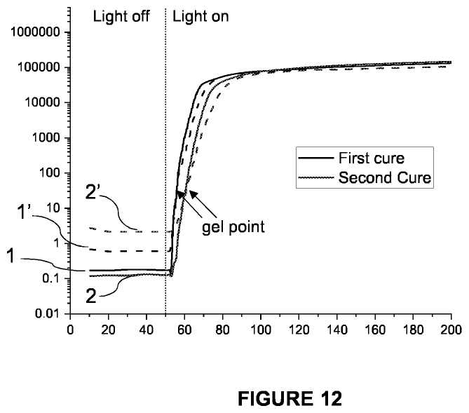

FIG. 12 is photorheology analysis showing the first curing of the original resin composition of Example 6 compared to the second cure of the recycled resin composition of FIG. 11.

Referring now to FIG. 1, there is shown a general scheme for the esterification reaction of lipoic acid (100) with an alcohol (101) to form a lipoate (102). The lipoate (102) is for use as a reactive diluent (103) or crosslinker (104) in the resin composition of the invention. The reaction is performed using DMAP (4-dimethylaminopyridine, CAS number: 1122-58-3) and EDC·HCl (1-ethyl-3-(3-dimethylaminopropyl) carbodiimide·HCl, CAS number: 25952-53-8) in DCM (dichloromethane) at 0° C. using the following general method.
Lipoic acid (1.2 molar equiv. per-OH group in the alcohol or diol or triol), alcohol or diol or triol (1.0 molar equiv.), DMAP (1.0-1.2 equiv. per-OH group in the alcohol or diol or triol) were placed in an oven-dried 2-neck round-bottom flask. Dichloromethane (DCM) (0.5 M) was added to the flask and the mixture was stirred for ca. 10 minutes. Note: the DCM did not have to be rigorously dried and reagent grade solvent was adequate for the reaction. The reaction mixture was then cooled to 0° C. in an ice-water bath and EDC·HCl (1.0-1.2 molar equiv. per-OH group in the alcohol or diol or triol) was added portion-wise over 5 minutes. The reaction was stirred at 0° C., slowly warming in the bath overnight (c.a. 16 hours). The reaction mixture was transferred to a separatory funnel and diluted with DCM. The organic layer was washed with 1 M HCl (3×), water (1×), saturated NaHCO₃ solution (3×), water (1×), and brine (1×). The organic layer was dried using MgSO₄ and concentrated in vacuo to afford the spectroscopically pure compound.

Referring now to FIG. 2, there is shown Examples of reactive diluents (103) for use in the resin composition of the invention. The reactive diluents (103) of the invention are synthesised in the reaction shown in FIG. 1 using a mono-alcohol (101) to produce a mono-functional “1-armed” structure having one cyclic disulphide group.

There is shown ethyl lipoate (103a) synthesised from lipoic acid and ethanol, menthyl lipoate (103b) synthesised from lipoic acid and menthol, guaiacol lipoate (103c) synthesised from lipoic acid and guaiacol, stearyl lipoate (103d) synthesised from lipoic acid and 1-octadecanol, isobornyl lipoate (103e) synthesised from lipoic acid and isobomeol, and geranyl lipoate (103f) synthesised from lipoic acid and geraniol.

Referring now to FIG. 3, there is shown Examples of crosslinkers (104) for use in the resin composition of the invention. The crosslinkers (104) of the invention are synthesised in the reaction shown in FIG. 1 using a diol or a triol to product a di- or tri-functional “2-armed” or “3-armed” structure having two or three cyclic disulphide groups respectively. To provide a crosslinker with greater numbers of cyclic disulphides an appropriate alcohol can be used.

There is shown isosorbide lipoate (104a) synthesised from lipoic acid and isosorbitol, and glyceryl lipoate (104b) synthesised from lipoic acid and glycerol.

Selected reactive diluents (103) and crosslinkers (104) were combined to form resin compositions according to the invention (see Examples below).

In order that the invention may be further understood, reference is made to the following examples:

### EXAMPLES 1 TO 4

The following Example resin compositions of the invention were prepared and included TPO-L (ethyl phenyl (2,4,6-trimethylbenzoyl)phosphinate (CAS number: 84434-11-7) at 1 wt. % (relative to total weight of resin) as a photoinitiator.

| | | | Concentration of |
|---|---|---|---|
| | Relative amount of | Relative amount of | disulphide bonds |
| | menthyl lipoate (103b) | isosorbide lipoate (104a) | (wt. %) in resin |
| Example | (wt. %) | (wt. %) | composition |
| 1 | 70 | 30 | 20.4 |
| 2 | 50 | 50 | 21.6 |
| 3 | 30 | 70 | 22.8 |
| 4 | 10 | 90 | 23.9 |

The concentration of disulphide bonds in the resin composition is shown in the table. As an example calculation, the concentration of disulphide bonds (wt. %) in the resin composition of Example 1 is calculated as follows:

$$( i )$$

$$Concentration of disulphide bonds in reactive diluent ( wt . \% ) = [ \text{} ( Number of disulphide bonds in reactive diluent \times RMM of disulphide ) / RMM of reactive diluent ] \times 100$$

$$Concentration of disulphide bonds in reactive diluent \text{} ( wt . \% ) = [ ( 1 \times 64.12 g {mol}^{- 1} ) / 344.57 g {mol}^{- 1} ] \times 100 = 18.6 wt . \%$$

$$( ii )$$

$$Concentration of disulphide bonds in crosslinker ( wt . \% ) = [ \text{} ( Number of disulphide bonds in crosslinker \times RMM of disulphide ) / RMM of crosslinker ] \times 100$$

$$Concentration of disulphide bonds in crosslinker \text{} ( wt . \% ) = [ ( 2 \times 64.12 g {mol}^{- 1} ) / 522.75 g {mol}^{- 1} ] \times 100 = 24.5 wt . \%$$

$$( iii )$$

$$Concentration of disulphide bonds ( wt . \% ) in resin composition = ( Concentration of disulphide bonds in reactive diluent \times wt . \% of \text{} reactive diluent in resin composition ) + ( Concentration of disulphide bonds in crosslinker \times wt . \% of crosslinker in resin composition )$$

$$( 18.6 wt . \% \times 0.7 ) + ( 24.5 wt . \% \times 0.3 ) = 20.4 wt . \%$$

Resin compositions of Examples 1 to 4 were cured with UV light (300-400 nm) to form 2D photoset films of 1 mm thickness. The films were then post-cured at 60° C. for 18 hours.

Referring now to FIG. 4, there is shown a Differential Scanning calorimetry (DSC) thermogram comparing 2D photosets from resin compositions of Examples 1 to 4 (Ex. 1, Ex. 2, Ex. 3, Ex. 4).

Referring also to FIG. 5, there is shown tensile testing of the 2D photosets from resin compositions of Examples 1 to 4.

The data in FIGS. 4 and 5 shows that the thermal and mechanical properties of the crosslinked polymer may be varied by changing the ratio of the reactive diluent to the crosslinker in the resin composition of the invention. This is because the crosslinking density may be modulated by changing the ratio of the reactive diluent to the crosslinker. It is shown that increasing the amount of isosorbide lipoate (104a) in the resin composition causes the effective crosslinking density to increase, which leads to an increase in both the glass transition (T_{g}) and the tensile strength.

### EXAMPLES 5 TO 7

The following Example resin compositions of the invention were prepared using TPO-L (ethyl phenyl (2,4,6-trimethylbenzoyl)phosphinate (CAS number: 84434-11-7) at 1 wt. % (relative to total weight of resin) as a photoinitiator.

| | | | Concentration of |
|---|---|---|---|
| | | Relative amount of | disulphide bonds |
| | Relative amount of ethyl | glycerol lipoate (104b) | (wt. %) in resin |
| Example | lipoate (103a) (wt. %) | (wt. %) | composition |
| 5 | 50 | 50 | 28.3 |
| 6 | 30 | 70 | 28.7 |
| 7 | 10 | 90 | 29.1 |

Referring now to FIG. 6, there is shown a Differential Scanning calorimetry (DSC) thermogram comparing 2D photosets from resin compositions of Examples 5 to 7 (Ex. 5, Ex. 6, Ex. 7).

Referring also to FIG. 7, there is shown tensile testing of the 2D photosets from resin compositions of Examples 5 to 7.

The data in FIGS. 6 and 7 similarly shows that the thermal and mechanical properties of the crosslinked polymer may be varied by changing the ratio of the reactive diluent to the crosslinker in the resin composition of the invention. Specifically, it is shown that the increasing the amount of glycerol lipoate (104b) in the resin composition causes the effective crosslinking density to increase, which leads to an increase in both the glass transition (T_{g}) and the tensile strength.

Referring now to FIG. 8, there is shown a reaction scheme 800 for depolymerisation of a 2D photoset crosslinked film of Example 3 containing menthyl lipoate (103b) (30 wt. %) and isosorbide lipoate (104a) (70 wt. %). A photograph of a crosslinked film 801 and the depolymerised film 802 is shown. The 2D photosets were depolymerised in 3 hours using catalytic amounts of phosphazene base (tert-butylimino-tris(dimethylamino)phosphorane (CAS number: 81675-81-2) and thiophenol in methyl tetrahydrofuran (MeTHF) at 80° C. The depolymerised film underwent filtration through alumina, and the solvent was evaporated to yield the recycled resin.

Referring also to FIG. 9, there is shown an 1H NMR spectrum of the depolymerised resin (802) of Example 3. It is shown that the depolymerized (recycled) resin was isolated in up to 90% yield, with a chemical composition that is comparable to the initial resin composition as determined by proton nuclear magnetic resonance (¹H NMR) spectroscopy.

Referring now to FIG. 10, there is shown a selection of 3D printed parts using the resin composition of the invention. The 3D printed parts were fabricated from a resin composition of Example 6 containing ethyl lipoate (103a) (30 wt. %) and glyceryl lipoate (104b) (70 wt. %) using DLP-based 3D printing with a 405 nm light source. Advantageously, the 3D printed resin did not require any added photoinitiator. This is because the layers are ˜50 μm thick, which is much thinner than the 2D photoset films which have a thickness of ˜1 mm, thus facilitating effective light penetration. It is shown that the 3D printed parts in FIG. 10 are high fidelity parts with micron-scale resolution.

Referring now to FIG. 11, there is shown a reaction scheme 1100 for depolymerisation of a 3D printed part shown in FIG. 10 from the resin composition of Example 6 containing ethyl lipoate (103a) (30 wt. %) and glyceryl lipoate (104b) (70 wt. %). A photograph of the partially crushed 3D printed part 1101, the pulverised 3D printed part, and the depolymerised part 1102 is shown. The 3D printed polymers were depolymerised in 3 hours using catalytic amounts of phosphazene base (tert-butylimino-tris(dimethylamino) phosphorane (CAS number: 81675-81-2) and thiophenol in methyl tetrahydrofuran (MeTHF) at 80° C. The depolymerised material underwent filtration through alumina, and the solvent was evaporated to yield the recycled resin.

Referring now to FIG. 12, there is shown photorheology analysis showing the first curing of the original resin composition of Example 6 compared to the second cure of the recycled resin composition shown in FIG. 11. There is shown the storage modulus for the first cure 1 and the second cure 2, and the loss modulus for the first cure 1′ and the second cure 2′.

Advantageously, the recycled resin shows similar curing times and modulus values compared to the original resin. It is shown that before curing, the loss modulus is greater than the storage modulus, which means the resin is liquid. After the light is switched on at around 50 seconds, the storage modulus crosses over (i.e. the gel point) and becomes higher than the loss modulus. Both the first and second cure quickly reach the gel point (5-10 seconds after switching on the light) and the line shapes are very similar. This shows that they have similar curing profiles and mechanical properties.

Advantageously, the resin composition of the invention may be implemented using industry-standard vat polymerization printing techniques such as DLP, stereolithography (SLA), or may be implemented by direct ink write or inkjet printing. More advantageously, the resin composition of the invention does not contain (meth)acrylate functionality but has many of the advantages that (meth)acrylate-based resins of the prior art offer. Consequently, the resin composition of the invention offers a less toxic, more environmentally friendly, and more sustainable alternative to (meth)acrylate-based resins. Even more advantageously, the properties of the resulting 3D printed part may be modulated by varying the relative ratio of reactive diluent to crosslinker within the resin composition. For example, by increasing the relative amount of reactive diluent, the resulting 3D printed material is softer and more stretchable. Conversely, by increasing the relative amount of crosslinker, the resulting 3D printed material is strong and brittle. Yet more advantageously, the crosslinked polymer of the invention may be depolymerised back to the original resin composition, which may be repolymerised once again, in a closed-loop cycle. This recyclability is able to cut waste generation, and to cut resin and material costs.

It will be appreciated by those skilled in the art that several variations to the aforementioned embodiments are envisaged without departing from the scope of the invention. For example, the resin composition of the invention may contain more than one reactive diluent and/or more than one type of crosslinker. This may allow for specific tuning of properties, which may be advantageous. For example, a resin composition of the invention may contain 70:30 parts reactive diluent to crosslinker, wherein the reactive diluent comprises a 50:50 ratio of ethyl lipoate (103a) and geranyl lipoate (103f), and the crosslinker comprises isosorbide lipoate (104a) only. In another example, a resin composition of the invention may contain, 30:70 parts reactive diluent to crosslinker, wherein the reactive diluent comprises menthyl lipoate (103b) only, and the crosslinker comprises a 20:80 ratio of isosorbide lipoate and glyceryl lipoate (104b). By varying the amount and type of reactive diluent and crosslinker in the resin composition of the invention, the thermal and mechanical properties may be further modulated to produce materials, e.g. 3D printed parts, with a wide range of properties. Moreover, the structures of the reactive diluent and/or crosslinker are not limited to those shown in FIGS. 2 and 3. Many other reactive diluent and crosslinker structures are envisaged simply by selecting different alcohols, diols, or triols for use in the esterification reaction with lipoic acid. This type of modification may also be performed to modulate the thermal and mechanical properties of the resulting crosslinked polymer, e.g. 3D printed part. Moreover, starting materials other than lipoic acid, which contain a cyclic disulphide bond may be used to synthesis the reactive diluent and/or the crosslinker.

It will also be appreciated by those skilled in the art that any number of combinations of the aforementioned features and/or those shown in the appended drawings provide clear advantages over the prior art and are therefore within the scope of the invention described herein.

1-41. (canceled)

42. A photocurable resin composition comprising a crosslinker, the crosslinker comprising plural cyclic disulphide groups and wherein the concentration of disulphide bonds in the resin composition is at least 10 wt. %.

43. The photocurable resin composition of claim 42, wherein the concentration of disulphide bonds in the resin composition is at least 11 wt %.

44. The photocurable resin composition of claim 42, further comprising one of:
a reactive diluent,
a non-reactive diluent, or
a reactive diluent and a non-reactive diluent.

45. The photocurable resin composition of claim 44, comprising a non-reactive diluent and wherein the non-reactive diluent is a solvent for the cross-linker, the solvent being selectable from one of acetone, dimethyl sulfoxide (DMSO), N-methyl-2-pyrrolidone (NMP), dichloromethane (DCM), tetrahydrofuran (THF) or a mixture of two or more of acetone, dimethyl sulfoxide (DMSO), N-methyl-2-pyrrolidone (NMP), dichloromethane (DCM), tetrahydrofuran (THF).

46. The photocurable resin composition of claim 44, wherein the reactive diluent has fewer disulphide bonds than the crosslinker.

47. The photocurable resin composition of claim 44, wherein the reactive diluent has a structure selected from either structure a) or structure b) below: 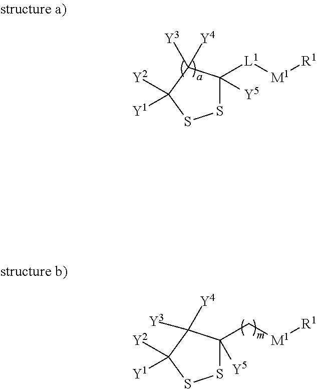
wherein in each case:
M¹ is selected from O, —(C═O)—, —(C═O)—O—, —O—(C═O)—, —O—(C═O)—O—, N, —N—(C═O)—, —(C═O)—N—, —N—(C═O)—O—, —O—(C═O)—N—, —(N═C)—, —(C═O)—O—(C═O)—;
R¹ is selected from C₁₋₂₀ alkyl, C₂₋₂₀ alkenyl, C₁₋₂₀ haloalkyl, C₂₋₂₀ alkynyl, C₃₋₉ cycloalkyl, C₃₋₉ aryl, C₃₋₉ heteroaryl, C₃₋₉ heterocyclyl;
wherein R¹ is optionally substituted with one or more of H, D, F, Cl, Br, I, OH, C₁-C₄ alkoxy, C₂₋₆ alkenyl, C₁₋₆ haloalkyl, C₂₋₆ alkynyl, OR^{x}, NHR^{y}, NR^{y}R^{z} and R^{x}, R^{y}, and R^{z} are independently selected from H, C₁₋₆ alkyl, C₂₋₆ alkenyl, C₁₋₆ haloalkyl, C₂₋₆ alkynyl;
Y¹, Y², Y³, Y⁴, Y⁵ are independently selected from H, D, F, Cl, Br, I, OH, C₁-C₄ alkoxy, C₂₋₆ alkenyl, C₁₋₆ haloalkyl, C₂₋₆ alkynyl, OR^{x}, NHR^{y}, NR^{y}R^{z} and R^{x}, R^{y}, and R^{z} are independently selected from H, C₁₋₆ alkyl, C₂₋₆ alkenyl, C₁₋₆ haloalkyl, C₂₋₆ alkynyl;
wherein when the reactive diluent has structure a)
a is selected from 1, 2, 3, 4, or 5;
L¹ is selected from C₁₋₆ alkylene optionally substituted with one or more substituents independently selected from H, D, F, Cl, Br, I, OH, C₁-C₄ alkoxy, OR^{x}, NHR^{y}, NR^{y}R^{z}, and R^{x}, R^{y}, and R^{z} are independently selected from H, C₁₋₆ alkyl, C₂₋₆ alkenyl, C₁₋₆ haloalkyl, C₂₋₆ alkynyl;
wherein when the reactive diluent has structure b)
m is selected from 1, 2, 3, 4, 5, 6.

48. The photocurable resin composition of claim 47, wherein when the reactive diluent has structure a) at least one of the following conditions are satisfied:
a is 1;
Y¹, Y², Y³, Y⁴, Y⁵ are H;
M¹ is —(C═O)—O—;
R¹ is C₁₋₂₀ alkyl;
and wherein when the reactive diluent has structure b) at least one of the following conditions are satisfied:
m is 4;
Y¹, Y², Y³, Y⁴, Y⁵ are H;
M¹ is —(C═O)—O—; and/or
R¹ is C₁₋₂₀ alkyl.

49. The photocurable resin composition of claim 47, wherein R¹ is selected from (i) to (vi):

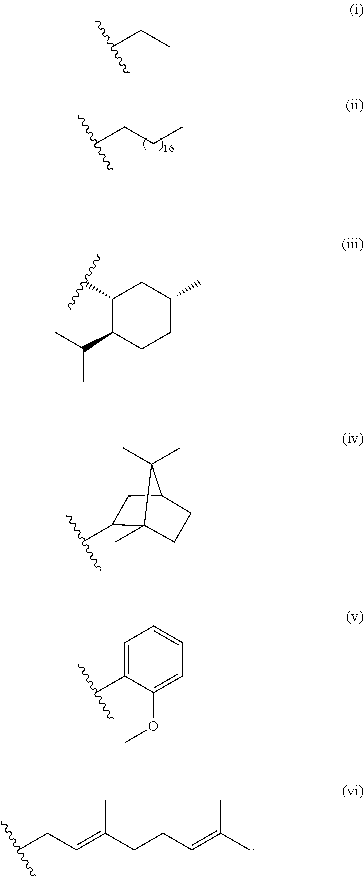

50. The photocurable resin composition of claim 44, wherein the reactive diluent is selected from one or more of the following compounds:

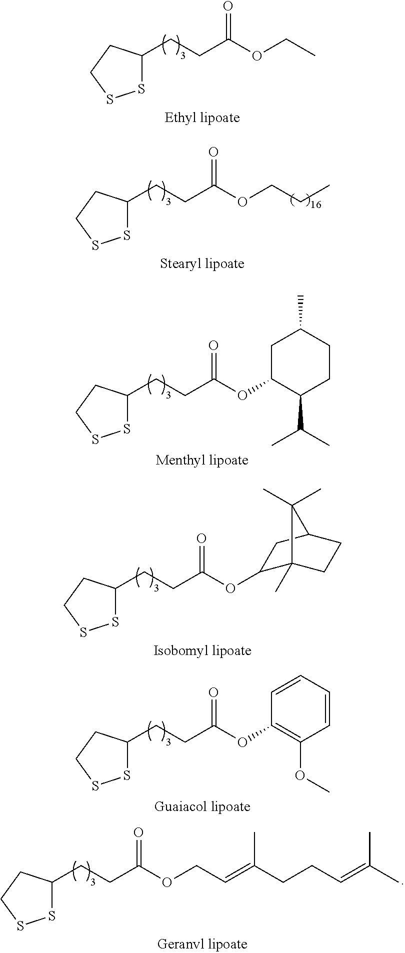

51. The photocurable resin composition of claim 44, comprising a further reactive diluent and/or a further crosslinker.

52. The photocurable resin composition of claim 42, wherein the crosslinker has a structure selected from one of structure c), c′), d) or d′): 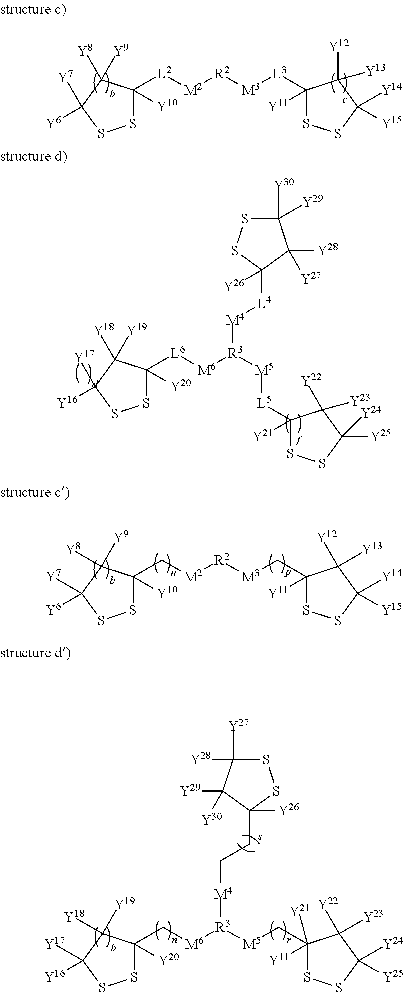
wherein when the crosslinker has structure c)
b and c are independently selected from 1, 2, 3, 4, or 5;
Y⁶, Y⁷, Y⁸, Y⁹, Y¹⁰, Y¹¹, Y¹², Y¹³, Y¹⁴, Y¹⁵ are independently selected from H, D, F, Cl, Br, I, OH, C₁-C₄ alkoxy, C₂₋₆ alkenyl, C₁₋₆ haloalkyl, C₂₋₆ alkynyl, OR^{x}, NHR^{y}, NR^{y}R^{z} and R^{x}, R^{y}, and R^{z} are independently selected from H, C₁₋₆ alkyl, C₂₋₆ alkenyl, C₁₋₆ haloalkyl, C₂₋₆ alkynyl;
L² and L³ are independently selected from C₁₋₆ alkylene optionally substituted with one or more substituents independently selected from H, D, F, Cl, Br, I, OH, C₁-C₄ alkoxy, OR^{x}, NHR^{y}, NR^{y}R^{z}, and R^{x}, R^{y}, and R^{z} are independently selected from H, C₁₋₆ alkyl, C₂₋₆ alkenyl, C₁₋₆ haloalkyl, C₂₋₆ alkynyl;
M² and M³ is independently selected from O, —(C═O)—, —(C═O)—O—, —O—(C═O)—, —O—(C═O)—O—, N, —N—(C═O)—, —(C═O)—N—, —N—(C═O)—O—, —O—(C═O)—N—, —(N═C)—, —(C═O)—O—(C═O)—;
R² is selected from C₁₋₂₀ alkylene, C₂₋₂₀ alkenyl, C₁₋₂₀ haloalkyl, C₂₋₂₀ alkynyl, C₃₋₉ cycloalkyl, C₃₋₉ aryl, C₃₋₉ heteroaryl, C₃₋₉ heterocyclyl;
wherein when the crosslinker has structure c′)
n and p are independently selected from 1, 2, 3, 4, 5, 6;
Y⁶, Y⁷, Y⁸, Y⁹, Y¹⁰, Y¹¹, Y¹², Y¹³, Y¹⁴, Y¹⁵ are independently selected from H, D, F, Cl, Br, I, OH, C₁-C₄ alkoxy, C₂₋₆ alkenyl, C₁₋₆ haloalkyl, C₂₋₆ alkynyl, OR^{x}, NHR^{y}, NR^{y}R^{z} and R^{x}, R^{y}, and R^{z} are independently selected from H, C₁₋₆ alkyl, C₂₋₆ alkenyl, C₁₋₆ haloalkyl, C₂₋₆ alkynyl;
wherein R² is optionally substituted with one or more of H, D, F, Cl, Br, I, OH, C₁-C₄ alkoxy, C₂₋₆ alkenyl, C₁₋₆ haloalkyl, C₂₋₆ alkynyl, OR^{x}, NHR^{y}, NR^{y}R^{z} and R^{x}, R^{y}, and R^{z} are independently selected from H, C₁₋₆ alkyl, C₂₋₆ alkenyl, C₁₋₆ haloalkyl, C₂₋₆ alkynyl;
M² and M³ is independently selected from O, —(C═O)—, —(C═O)—O—, —O—(C═O)—, —O—(C═O)—O—, N, —N—(C═O)—, —(C═O)—N—, —N—(C═O)—O—, —O—(C═O)—N—, —(N═C)—, —(C═O)—O—(C═O)—;
R² is selected from C₁₋₂₀ alkylene, C₂₋₂₀ alkenyl, C₁₋₂₀ haloalkyl, C₂₋₂₀ alkynyl, C₃₋₉ cycloalkyl, C₃₋₉ aryl, C₃₋₉ heteroaryl, C₃₋₉ heterocyclyl;
wherein when the crosslinker has structure d)
d, e, and f are independently selected from 1, 2, 3, 4, or 5;
Y¹⁶, Y¹⁷, Y¹⁸, Y¹⁹, Y²⁰, Y²¹, Y²², Y²³, Y²⁴, Y²⁵, Y²⁶, Y²⁷, Y²⁸, Y²⁹, Y³⁰ are independently selected from H, D, F, Cl, Br, I, OH, C₁-C₄ alkoxy, C₂₋₆ alkenyl, C₁₋₆ haloalkyl, C₂₋₆ alkynyl, OR^{x}, NHR^{y}, NR^{y}R^{z} and R^{x}, R^{y}, and R^{z} are independently selected from H, C₁₋₆ alkyl, C₂₋₆ alkenyl, C₁₋₆ haloalkyl, C₂₋₆ alkynyl;
L⁴, L⁵, and L⁶ are independently selected from C₁₋₆ alkylene;
M⁴, M⁵, and M⁶ is independently selected from O, —(C═O)—, —(C═O)—O—, —O—(C═O)—, —O—(C═O)—O—, N, —N—(C═O)—, —(C═O)—N—, —N—(C═O)—O—, —O—(C═O)—N—, —(—N═C—)—, —(C═O)—O—(C═O)—;
R³ is selected from C₁₋₂₀ alkylene, C₂₋₂₀ alkenyl, C₁₋₂₀ haloalkyl, C₂₋₂₀ alkynyl, C₃₋₉ cycloalkyl, C₃₋₉ aryl, C₃₋₉ heteroaryl, C₃₋₉ heterocyclyl,
and wherein when the cross linker has the general structure d′)
q, r, and s are independently selected from 1, 2, 3, 4, 5, 6;
Y¹⁶, Y¹⁷, Y¹⁸, Y¹⁹, Y²⁰, Y²¹, Y²², Y²³, Y²⁴, Y²⁵, Y²⁶, Y²⁷, Y²⁸, Y²⁹, Y³⁰ are independently selected from H, D, F, Cl, Br, I, OH, C₁-C₄ alkoxy, C₂₋₆ alkenyl, C₁₋₆ haloalkyl, C₂₋₆ alkynyl, OR^{x}, NHR^{y}, NR^{y}R^{z} and R^{x}, R^{y}, and R^{z} are independently selected from H, C₁₋₆ alkyl, C₂₋₆ alkenyl, C₁₋₆ haloalkyl, C₂₋₆ alkynyl;
M⁴, M⁵, and M⁶ is independently selected from O, —(C═O)—, —(C═O)—O—, —O—(C═O)—, —O—(C═O)—O—, N, —N—(C═O)—, —(C═O)—N—, —N—(C═O)—O—, —O—(C═O)—N—, —(—N═C—)—, —(C═O)—O—(C═O)—;
R³ is selected from C₁₋₂₀ alkylene, C₂₋₂₀ alkenyl, C₁₋₂₀ haloalkyl, C₂₋₂₀ alkynyl, C₃₋₉ cycloalkyl, C₃₋₉ aryl, C₃₋₉ heteroaryl, C₃₋₉ heterocyclyl,

53. The photocurable resin composition of claim 52, wherein when the crosslinker has structure c) at least one of the following conditions are satisfied:
b and c are each 1;
Y⁶, Y⁷, Y⁸, Y⁹, Y¹⁰, Y¹¹, Y¹², Y¹³, Y¹⁴, Y¹⁵ are H;
L² and/or L³ is C₁₋₆ alkylene, e.g. an unsubstituted C₁₋₆ alkylene, e.g. C₄H₈;
M² and/or M³ are —(C═O)—O—; and/or
R² is a C₃₋₉ heterocyclyl;
wherein when the crosslinker has structure c′) at least one of the following conditions are satisfied:
n and p are each 4;
Y⁶, Y⁷, Y⁸, Y⁹, Y¹⁰, Y¹¹, Y¹², Y¹³, Y¹⁴, Y¹⁵ are H;
M² and/or M³ are —(C═O)—O—, and/or
R² is a C₃₋₉ heterocyclyl;
wherein when the crosslinker has structure d) at least one of the following conditions are satisfied:
d, e, and f are each 1;
Y¹⁶, Y¹⁷, Y¹⁸, Y¹⁹, Y²⁰, Y²¹, Y²², Y²³, Y²⁴, Y²⁵, Y²⁶, Y²⁷, Y²⁸, Y²⁹, Y³⁰ are H;
M⁴ and/or M⁵ and/or M⁶ is —(C═O)—O—; and/or
R³ is C₁₋₂₀ alkylene;
wherein when the crosslinker has structure c′) at least one of the following conditions are satisfied:
q, r, and s are each 4;
Y¹⁶, Y¹⁷, Y¹⁸, Y¹⁹, Y²⁰, Y²¹, Y²², Y²³, Y²⁴, Y²⁵, Y²⁶, Y²⁷, Y²⁸, Y²⁹, Y³⁰ are H;
M⁴ and/or M⁵ and/or M⁶ is —(C═O)—O—; and/or
R³ is C₁₋₂₀ alkylene.

54. The photocurable resin composition of claim 52, wherein when the crosslinker has structure c) or c′) R² is (vii): 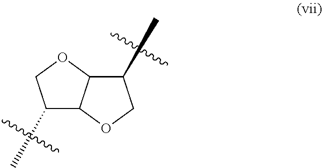
and wherein when the crosslinker has structure d) or d′) R³ is (viii).

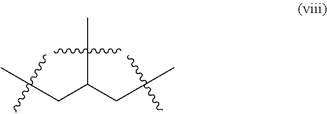 [SMILES: *CC(*)C*]

55. The photocurable resin composition of claim 42, wherein the crosslinker is a reaction product of a reaction between lipoic acid and a diol or a triol.

56. The photocurable resin composition of claim 42, wherein the crosslinker comprises a compound selected from one or more of the following compounds:

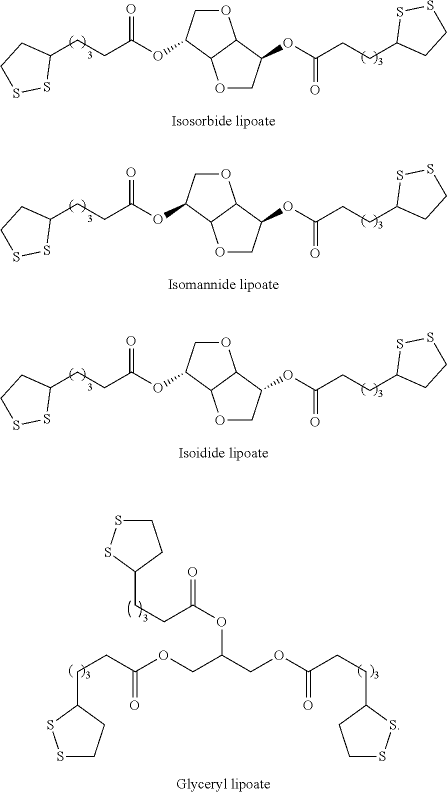

57. The photocurable resin composition of claim 42, further comprising one or more additives, and wherein said one or more additives may be selected from:
a photoinitiator;
a radical inhibitor;
a plasticizer;
an opaquing agent;
mixtures of one or more of the above.

58. A crosslinked polymer fabricated from the photocurable resin composition of claim 42.

59. A method of depolymerising a crosslinked polymer wherein the polymer comprises disulphide bonds and no acrylate bonds, the method comprising contacting the crosslinked polymer with an organic base, for example a non-nucleophilic strong base and/or diazabicyclo[5.4.0]undec-7-ene (DBU) (CAS number: 6674-22-2), and/or triethylamine (CAS number: 121-44-8); and a thiol to obtain monomer units.

60. The method of claim 59, comprising heating the crosslinked polymer with the organic base and the thiol to a temperature of greater than or equal to 40° C.

61. The method of claim 59, comprising forming, by said depolymerisation, monomer units from the crosslinked polymer, and subsequently polymerising the monomer units to form a crosslinked polymer, the forming method comprising exposing the monomer units to light.
